(19) United States
(12) Patent Application Publication
(10) Pub. No.: US 2009/0172100 A1
(43) Pub. Date: Jul. 2, 2009

(54) DERIVING AND COMMUNICATING ATTENTION SPANS IN COLLABORATIVE APPLICATIONS

(75) Inventors: Sean Callanan, Dublin (IE); Gary Denner, County Kildare (IE); Ruthie D. Lyle, Durham, NC (US); Patrick J. O'Sullivan, Dublin (IE); Carol S. Zimmet, Boxborough, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/967,789

(22) Filed: Dec. 31, 2007

(51) Int. Cl. G06F 15/16

(52) U.S. Cl. 709/205

(57) ABSTRACT

Embodiments of the present invention address deficiencies of the art in respect to collaborative computing and provide a method, system and computer program product for deriving and communicating attention spans in a collaborative computing environment. In an embodiment of the invention, an attention span management method can be provided for a collaborative computing environment. The method can include monitoring computer activity for a collaborator to a collaboration, computing an attention span based upon the monitored computing activity, and generating an alert in the collaboration if the attention span crosses a threshold boundary indicating an unacceptable level of distraction for the collaboration.

### BACKGROUND OF THE INVENTION

1. Field of the Invention

The present invention relates to the field of collaborative computing and more particularly to participant management in a collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Critical to collaborative computing are group real time communications like Web conferencing and e-meetings, shared document editing in a team room and white boarding and N-way chats. Intended to mimic real world collaborations, real time virtual gatherings provide a close approximation to different individuals working together at one table in a single room. Even still, aspects of reality remain absent in the virtual gathering. Most notably, in the virtual world, one lacks the ability to detect the physical and emotional state of a fellow collaborator whereas in the real world, a mere glance at the facial expression of the fellow collaborator can be telling.

It will be recognized, for example, that in an ordinary gathering in the real world, it can be visually determined when a participant to the gathering remains engaged in the collaboration, or when the participant to the gathering has become distracted. Depending upon the identity of the participant, it may be permissible for the participant to provide less than full attention to the gathering. In other circumstances, it may be required that the participant remain fully engaged in the gathering.

Yet, one presenting at the gathering can manage the gathering responsive to visual feedback provided by the participants to the gathering demonstrating degrees of attention provided by the participants to the gathering. This is not possible, however, in the virtual world where a determination of the attention levels of different collaborators cannot be confirmed through traditional visual and auditory senses. As a result, the nature and conduct of a virtual collaboration in a collaborative computing system cannot adjust dynamically in response to the loss of attention span by a participant to the collaboration.

### BRIEF SUMMARY OF THE INVENTION

Embodiments of the present invention address deficiencies of the art in respect to collaborative computing and provide a novel and non-obvious method, system and computer program product for deriving and communicating attention spans in a collaborative computing environment. In an embodiment of the invention, an attention span management method can be provided for a collaborative computing environment such as an e-learning environment with learners as collaborators, instructors and moderators. The method can include monitoring computer activity for a collaborator to a collaboration, computing an attention span based upon the monitored computing activity, and generating an alert in the collaboration if the attention span crosses a threshold boundary indicating an unacceptable level of distraction for the collaboration.

For instance, monitoring computer activity for a collaborator to a collaboration can include monitoring received and transmitted instant messages for the collaborator to the collaboration. As another example, monitoring computer activity for a collaborator to a collaboration can include monitoring user interaction with other applications by the collaborator. In one aspect of the embodiment, computing an attention span based upon the monitored computing activity can include assigning a value as an attention span pre-assigned to the monitored activity or a combination of monitored activities. The assignment of the value can be performed by an administrator, a moderator or a participant. In the latter circumstance of a combination of monitored activities, computing an attention span based upon the monitored computing activity can include assigning a value for the attention span that has been pre-assigned to the monitored activity and weighting the assigned value according to a context of the collaboration.

Optionally, a user interface element can provide a dynamic view of the computed attention span for an end user relative to the computed attention spans of other users. For example, the user interface element can be a graduated progress bar. Additionally, a user interface element can provide a visual alert where the computed attention span for a user falls below a required level. In this regard, the user interface element can be rendered distinctive through color changes or flashing, by way of example. Even yet further, reporting can be enabled for the computed attention spans of all collaborators to a collaboration. The reporting can include collaborator to collaborator comparisons of computed attention spans, and content portion to content portion comparisons of computed attention spans.

In another embodiment of the invention, a collaboration data processing system can be configured for attention span management. The system can include a collaboration server providing a collaboration such as an e-meeting, a Web conference or a team room to name a few examples, for collaborators through collaborative clients over a computer communications network. The system further can include monitors, each coupled to a different one of the clients. Finally, the system can include attention span management logic. The logic can include program code enabled to computing an attention span based upon a monitored computing activity provided by a selected one of the monitors coupled to a selected one of the clients, and to generate an alert in the collaboration if the attention span crosses a threshold boundary indicating an unacceptable level of distraction for the collaboration.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for deriving and communicating attention spans in a collaborative computing environment;

FIG. 2 is a schematic illustration of a collaborative computing data processing system configured for deriving and communicating attention spans; and,

FIG. 3 is a flow chart illustrating a process for deriving and communicating attention spans in a collaborative computing environment.

### DETAILED DESCRIPTION OF THE INVENTION

Embodiments of the present invention provide a method, system and computer program product for deriving and communicating attention spans in a collaborative computing environment. In accordance with an embodiment of the present invention, an attention level can be determined for a collaborator participating in a collaboration based upon computing activities detected for the collaborator. Thereafter, if the determined the attention level falls below a threshold value, an alert can be provided to the collaborator or one or more other collaborators participating in the collaboration. In this way, the nature and conduct of a virtual collaboration in a collaborative computing system can adjust dynamically in response to the loss of attention span by a participant to the collaboration.

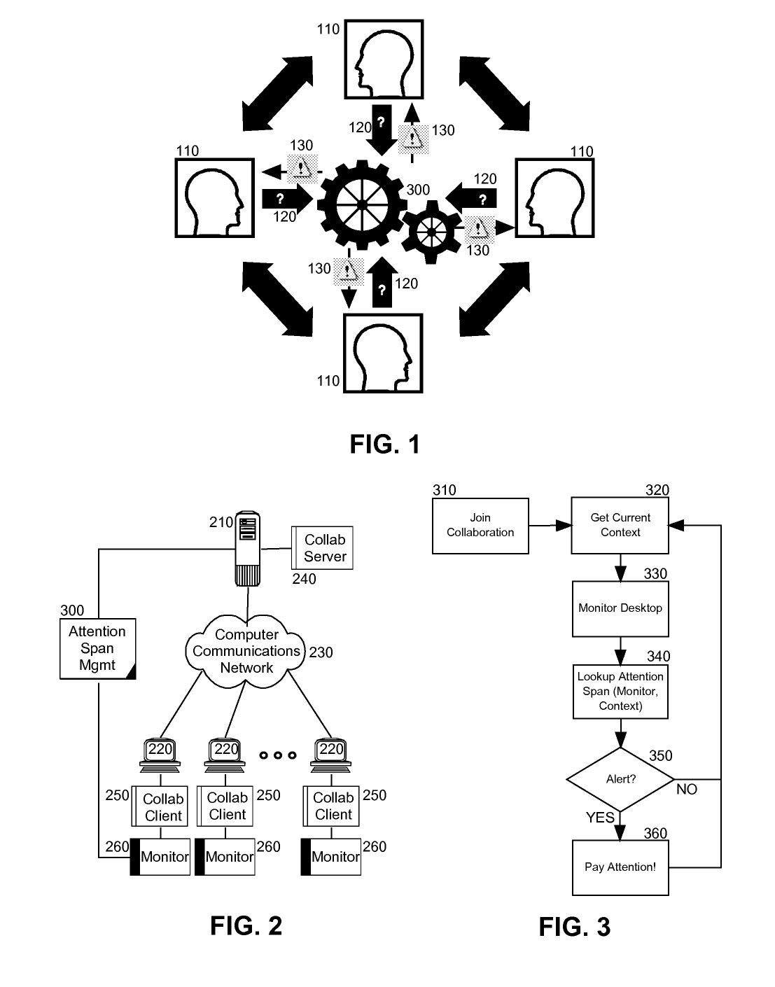

In illustration, FIG. 1 pictorially depicts a process for deriving and communicating attention spans in a collaborative computing environment. As shown in FIG. 1, different collaborators 110 can engage in a collaboration such as an e-meeting, group chat or Web conference. Throughout the course of the collaboration, each of the collaborators 110 can be monitored for computing activity such as the launch of or interaction with other computing applications, the receipt of messages such as instant messages or e-mails, or the initiation or participation in other communicative sessions such as the initiation of an audio chat or another collaboration.

Information 120 pertaining to the computing activity for each of the collaborators 110 can be monitored separately and, in response to such activity, an attention span manager 300 can compute an attention span for each of the collaborators 110. The computed attention span can produce a level of attention based upon the monitored computing activity and account not only for the computing activity of the monitored ones of the collaborators 110, but also for the context of the collaboration including the nature of a contemporaneous portion of the collaboration or a level of participation expected of the monitored ones of the collaborators 110 for the collaboration or a portion of the collaboration.

Once an attention span has been computed for a monitored one of the collaborators 110, the attention span can be compared with a threshold value to determine whether or not the monitored one of the collaborators 110 has become impermissibly distracted. However, the threshold value can vary according to a contemporaneous context of the collaboration. If the computed attention span exceeds the threshold, an alert 130 can be provided either to the monitored one of the collaborators 110, one or more others of the collaborators 110 or both. In this way, those other ones of the collaborators 110 participating in the collaboration can account for the distraction faced by the monitored one of the collaborators 110.

In further illustration, FIG. 2 schematically depicts a collaborative computing data processing system configured for deriving and communicating attention spans. The system can include a host computing platform 210 configured for communicative coupling to multiple different computing devices 220 over computer communications network 230. The host computing platform 210 can support the operation of a collaboration server 240 configured to manage a collaboration such as an e-meeting, a Web conference, a group chat and the like for participating collaboration clients 250, each operating in a different one of the computing devices 220.

A monitor 260 can be coupled to each of the collaboration clients 250. The monitor 260 can be a software agent programmed to detect computing interactions in a coupled one of the computing devices 220, such as instant messaging sessions and inbound and outbound instant messages, e-mail clients and inbound and outbound e-mails, other launched applications receiving user input and the like. Notably, attention span management logic 300 can be coupled to the monitor 260 either as logic executing in a respective one of the computing devices 220, or as logic executing in the host computing platform 210, or as a service external to the computing devices 220 and the host computing platform 210.

The attention span management logic 300 can include program code enabled to compute an attention span for a collaborator participating in a collaboration based upon a number of factors relating to the computing activities of the collaborator, such as activity in one or more concurrently present applications including instant messaging sessions and e-mail clients. The program code further can be enabled to compare the computed attention span to a context for the collaboration, such as the contemporaneously experienced portion of the collaboration, or the nature and quantity of content presented in the collaboration. The program code yet further can be enabled to generate an alert to either the collaborator or another party whenever the computed attention span crosses a threshold value indicating an unacceptable amount of distraction. Optionally, the program code even yet further can be enabled to compare anticipated content in the collaboration to a required attention span and individual collaborators necessary to maintain the required attention span, in order to alert the individual collaborators in advance of the need to pay attention.

In further illustration of the operation of the attention span management logic 300, FIG. 3 is a flow chart illustrating a process for deriving and communicating attention spans in a collaborative computing environment. Beginning in block 310, a collaborator can join a collaboration, and in block 320 a context for the collaboration can be determined. For example, the type of content shared in the current activity as well as the quantity of content can be recognized as the context of the collaboration. In block 330, the desktop of the collaborator can be monitored for activity, for example the transmission and receipt of instant messages, user interface interactions with different executing applications and the like.

In block 340, an attention span can be computed based upon the monitored activity. For example, a table can be maintained of different monitored activities and combinations of activities corresponding to different attention span values. These values can be administrator defined, user defined, or autonomically defined based on normal distributions of the historically observed activities of other collaborators. Further the values can be weighted according to the context of the collaboration, such as whether or not the collaboration is a Web conference requiring a high degree of attentiveness, or a document sharing session requiring a lower degree of attentiveness.

In decision block 350 the computed and potentially weighted values can be compared to a threshold value consistent with the context of the collaboration. If the value exceeds the threshold indicating an unacceptable degree of distraction on the part of the collaborator, in block 360, an alert can be posted to the collaborator. Alternatively, an alert can be posted to a moderator or other participants to the collaboration. Yet further, an indicator of the value can be provided to the collaborator, to the moderator, or to a collaborator in a specified role such as supervisor or teacher, as a user interface element showing color coded or other visually distinctive indications of attention span levels. Finally, the historically computed attention span levels can be reported for the collaborator or for the collaboration as a whole in order to facilitate a review of the engaging nature of the collaboration.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An attention span management method for a collaborative computing environment, the method comprising:
monitoring computer activity for a collaborator to a collaboration;
computing an attention span based upon the monitored computing activity; and,
generating an alert in the collaboration if the attention span crosses a threshold boundary indicating an unacceptable level of distraction for the collaboration.

2. The method of claim 1, wherein monitoring computer activity for a collaborator to a collaboration, comprises monitoring received and transmitted instant messages for the collaborator to the collaboration.

3. The method of claim 1, wherein monitoring computer activity for a collaborator to a collaboration, comprises monitoring user interaction with other applications by the collaborator.

4. The method of claim 1, wherein computing an attention span based upon the monitored computing activity, comprises assigning a value as an attention span pre-assigned to the monitored activity.

5. The method of claim 1, wherein computing an attention span based upon the monitored computing activity, comprises assigning a value to the attention span that has been pre-assigned to a combination of monitored activities.

6. The method of claim 5, wherein computing an attention span based upon the monitored computing activity, comprises:
assigning a value for the attention span that has been pre-assigned to the monitored activity; and,
weighting the assigned value according to a context of the collaboration.

7. The method of claim 1, wherein generating an alert in the collaboration if the attention span crosses a threshold boundary indicating an unacceptable level of distraction for the collaboration, comprises alerting either a moderator or a collaborator for the collaboration.

8. The method of claim 1, further comprising:
identifying a collaborator required to maintain a requisite level of attention span for an anticipated portion of the collaboration; and,
alerting the identified collaborator in advance of the anticipated portion of the need to pay attention.

9. A collaboration data processing system configured for attention span management, the system comprising:
a collaboration server providing a collaboration for a plurality of collaborators through collaborative clients over a computer communications network;
a plurality of monitors, each coupled to a different one of the clients; and,
attention span management logic comprising program code enabled to computing an attention span based upon a monitored computing activity provided by a selected one of the monitors coupled to a selected one of the clients, and to generate an alert in the collaboration if the attention span crosses a threshold boundary indicating an unacceptable level of distraction for the collaboration.

10. The system of claim 9, wherein the collaboration is an e-meeting.

11. The system of claim 9, wherein the collaboration is a Web conference.

12. The system of claim 9, wherein the collaboration is a team room.

13. A computer program product comprising a computer usable medium embodying computer usable program code for attention span management, the computer program product comprising:
computer usable program code for monitoring computer activity for a collaborator to a collaboration;
computer usable program code for computing an attention span based upon the monitored computing activity; and,
computer usable program code for generating an alert in the collaboration if the attention span crosses a threshold boundary indicating an unacceptable level of distraction for the collaboration.

14. The computer program product of claim 13, wherein the computer usable program code for monitoring computer activity for a collaborator to a collaboration, comprises computer usable program code for monitoring received and transmitted instant messages for the collaborator to the collaboration.

15. The computer program product of claim 13, wherein the computer usable program code for monitoring computer activity for a collaborator to a collaboration, comprises computer usable program code for monitoring user interaction with other applications by the collaborator.

16. The computer program product of claim 13, wherein the computer usable program code for computing an attention span based upon the monitored computing activity, comprises computer usable program code for assigning a value as an attention span pre-assigned to the monitored activity.

17. The computer program product of claim 13, wherein the computer usable program code for computing an attention span based upon the monitored computing activity, comprises computer usable program code for assigning a value to the attention span that has been pre-assigned to a combination of monitored activities.

18. The computer program product of claim 17, wherein the computer usable program code for computing an attention span based upon the monitored computing activity, comprises:
computer usable program code for assigning a value for the attention span that has been pre-assigned to the monitored activity; and,
computer usable program code for weighting the assigned value according to a context of the collaboration.

19. The computer program product of claim 13, wherein the computer usable program code for generating an alert in the collaboration if the attention span crosses a threshold boundary indicating an unacceptable level of distraction for the collaboration, comprises computer usable program code for alerting either a moderator or a collaborator for the collaboration.

20. The computer program product of claim 13, further comprising:
computer usable program code for identifying a collaborator required to maintain a requisite level of attention span for an anticipated portion of the collaboration; and,
computer usable program code for alerting the identified collaborator in advance of the anticipated portion of the need to pay attention.
